(19) United States
(12) Patent Application Publication
(10) Pub. No.: US 2015/0063184 A1
(43) Pub. Date: Mar. 5, 2015

(54) INFORMATION PROCESSING SYSTEM, MANAGING APPARATUS, CONTROL METHOD FOR MANAGING APPARATUS, AND STORAGE MEDIUM

(71) Applicant: CANON KABUSHIKI KAISHA, Tokyo (JP)

(72) Inventor: Kozo Toda, Kokubunji-shi (JP)

(21) Appl. No.: 14/470,354

(22) Filed: Aug. 27, 2014

(30) Foreign Application Priority Data
Sep. 3, 2013 (JP) 2013-182483

(51) Int. Cl. H04W 52/02; H04W 88/08

(52) U.S. Cl. CPC H04W 52/0206; H04W 88/08
USPC 370/311

(57) ABSTRACT

An information processing system includes a wireless communication terminal, a plurality of information processing apparatuses having an access point, and a managing apparatus. The information processing system has a detecting unit configured to detect an energized state of the access point and send the energized state as a detection signal to the managing apparatus, and a control unit configured to switch the access point to a standby mode or a power-saving mode. The managing apparatus has a sending unit configured to send a mode switch signal to the control unit in response to the detection signal. When a position of the wireless communication terminal is detected, the sending unit sends the mode switch signal in response to the detection signal to the control unit for switching a predetermined number or more of access points to the standby mode, and the control unit switches the access points to the standby mode.

### BACKGROUND OF THE INVENTION

1. Field of the Invention

The present invention relates to an information processing system, a managing apparatus, a control method for the managing apparatus, and a storage medium configured to execute the control method. In particular, the present invention relates to the information processing system that includes a plurality of multifunction printer apparatuses provided with, for example, a facsimile function that includes a communication apparatus, and relates to a communication control method for that apparatus.

2. Description of the Related Art

Typically, network communication using a wireless LAN is widely used. Network communication is enabled between a backbone network and a wireless LAN terminal by wireless communication connection of the wireless LAN terminal and a wireless LAN access point connected to the backbone network by the wireless LAN. In recent years, in addition to network communication on the wireless LAN, a configuration has been proposed which uses the wireless LAN to detect a position of the wireless LAN terminal. A representative example of such a configuration is the time difference of arrival (TDOA) method. The TDOA method measures the position of the wireless LAN terminal from the difference in the arrival time of a wireless signal by simultaneous reception of the wireless signal sent from the wireless LAN terminal by a plurality of wireless LAN access points. Therefore, the principle of the TDOA method requires capture of the wireless signal from the wireless LAN terminal by the constantly required plurality of wireless LAN access points.

On the other hand, an MFP apparatus (information processing apparatus) provided with a plurality of functions such as copying, printing, scanning, FAX, and the like has found general application in office duties. In that context, in recent years, there has been a tendency to provide a new function(s) by execution of wireless LAN communication between a tablet PC or smartphone provided with a wireless LAN function that are undergoing the rapid expansion of application. More specifically, it has been proposed to provide a function such as printing or scanning by using a tablet PC or smartphone in a configuration in which wireless LAN communication is performed with a tablet PC or smartphone that is the wireless LAN terminal by mounting an access point for the wireless LAN in the MFP apparatus. When the access point for the wireless LAN is provided in the MFP apparatus, use in conjunction with a position detection system for the wireless LAN terminal as described above enables consideration of a new MFP function in which the position of the tablet PC or smartphone, that is the wireless LAN terminal, is detected and that position information is used.

However, when many users perform wireless communication on a system configured from the wireless LAN access point and the wireless LAN terminal, the plurality of wireless LAN access points must be provided in order to ensure connection of the wireless communication circuit. However, when the number of connected wireless LAN terminals is low, unnecessary power consumption can be avoided by operating only the required number of wireless LAN access points. In this context, Japanese Patent Laid-Open No. 2003-174456 discloses a system configured from the plurality of wireless LAN access points that is configured to shift the wireless LAN access points that are not required to a power-saving state.

Japanese Patent Laid-Open No. 2003-174456 discloses a method for shifting the wireless LAN access points that are not connected with the wireless LAN terminal to the power-saving state by controlling the wireless LAN access points to switch between a normal state and the power-saving state.

In the MFP apparatus, there is a strong demand to reduce unnecessary power consumption. As a result, a sleep mode is generally provided so that, when a function is not provided, the energized to unnecessary units in the apparatus is switched to an OFF state and thereby configures the power-saving state. When the wireless LAN access point is mounted in the MFP apparatus, as disclosed in the method in Japanese Patent Laid-Open No. 2003-174456, the wireless LAN access points that are not required are placed in an OFF state and the apparatus shifts to a sleep mode to thereby save power consumption.

However, on the other hand, when performing position detection of the wireless LAN terminal, operation of the plurality of wireless LAN access points is constantly required in a typical TDOA method. As a result, if respective MFP apparatuses shift randomly to a sleep mode in accordance with the method disclosed in Japanese Patent Laid-Open No. 2003-174456, the number of wireless LAN access points cannot cover the number that is required for position detection and therefore position detection of the wireless LAN terminal is not possible.

### SUMMARY OF THE INVENTION

The present invention provides an information processing system is configured to enable power saving and includes a plurality of MFP apparatuses that are constantly provided with wireless LAN access points that enable position detection of a wireless LAN terminal by use of the wireless LAN access points.

According to an aspect of the present invention, an information processing system that includes a wireless communication terminal; a plurality of information processing apparatuses having an access point configured to perform wireless communication with the wireless communication terminal; and a managing apparatus configured to manage the information processing apparatuses, wherein the information processing apparatuses comprises: a detecting unit configured to detect an energized state of the access point and send the energized state as a detection signal to the managing apparatus, and a control unit configured to switch the access point to a standby mode or a power-saving mode, wherein the managing apparatus comprises: a sending unit configured to send a mode switch signal to the control unit in response to the detection signal from the detecting unit, and wherein when a position of the wireless communication terminal is detected, the sending unit sends the mode switch signal in response to the detection signal to the control unit in order to switch a predetermined number or more of access points to the standby mode, and the control unit which has received the mode switch signal switches the access points to the standby mode.

According to the present invention, the information processing system can be configured for power saving, and includes the plurality of MFP apparatuses that are constantly provided with wireless LAN access points that enable position detection of the wireless LAN terminal by use of the wireless LAN access points may be provided.

Further features of the present invention will become apparent from the following description of exemplary embodiments (with reference to the attached drawings).

### BRIEF DESCRIPTION OF THE DRAWINGS

FIG. 1 is a diagram illustrating a schematic configuration of the MFP apparatus including a wireless LAN function.

FIG. 2 is a block diagram illustrating the MFP apparatus according to a first embodiment of the present invention.

FIG. 3 is a diagram illustrating position detection of a wireless LAN terminal according to a first embodiment of the present invention.

FIG. 4 is a flowchart illustrating the setting operation of a position detection and MFP control server.

FIG. 5 is a table illustrating a power consumption profile of the MFP apparatus.

FIG. 6 is a flowchart illustrating the operation of standby mode in the MFP apparatus.

FIG. 7 is a flowchart illustrating the operation of sleep mode in the MFP apparatus.

FIG. 8 is a flowchart illustrating the operation when performing position detection.

FIG. 9 is a table illustrating the respective MFP states resulting from operation of the position-detection MFP-control server.

FIG. 10 is a flowchart illustrating the operation when not performing position detection.

### BRIEF DESCRIPTION OF THE EMBODIMENTS

Hereinafter, preferred embodiments of the present invention will be described with reference to the drawings.

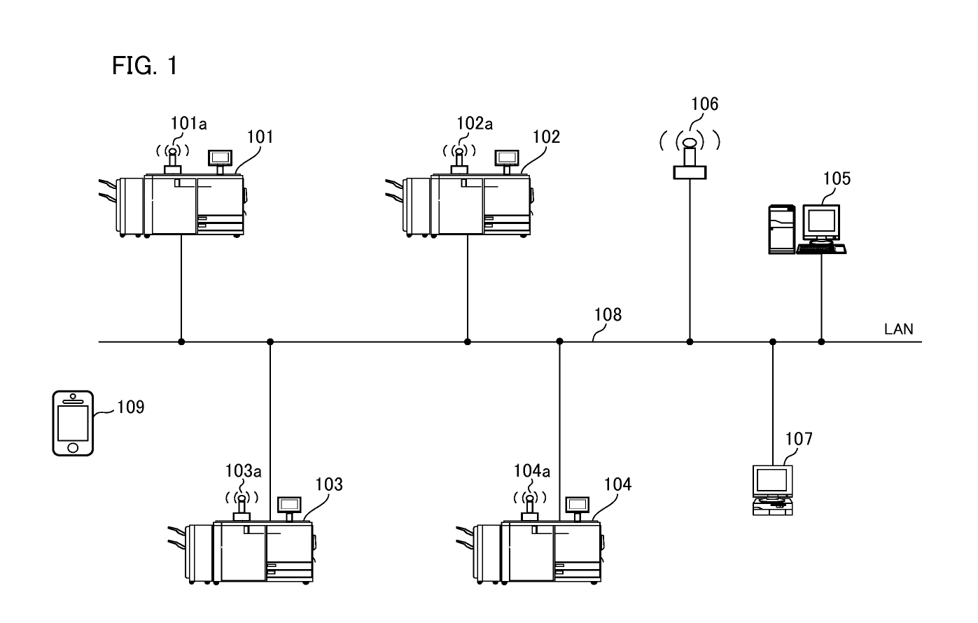

FIG. 1 is a diagram illustrating a schematic configuration of a system (information processing system) configured from an MFP apparatus provided with a wireless LAN function (wireless communication function) according to a first embodiment of the present invention. The MFP (information processing apparatus) 101 is the MFP apparatus, configured as a multifunction printer apparatus that includes functions such as copying, printing, scanning. An internal portion of the MFP 101 includes a wireless LAN access point 101a. An MFP 102, an MFP 103, and an MFP 104 denote the same MFP apparatus as the MFP 101, and respectively include a wireless LAN access point 102a, a wireless LAN access point 103a, and a wireless LAN access point 104a.

A position-detection MFP-control server (managing apparatus) 105 is a server (computer) configured to perform control of position detection of a wireless LAN terminal and control of power saving in the MFP 101 to 104. A position detection master point 106 performs synchronous control of the wireless LAN access point 101a to wireless LAN access point 104a when performing position detection of the wireless LAN terminal.

A client PC 107 is a PC used when a user performs network printing or network scanning operations. A LAN 108 is a local area network circuit, and performs communication control by various types of network protocols such as TCP/IP or the like. Furthermore, the LAN 108 is connected to the MFP 101 to the MFP 104, the position-detection MFP-control server 105, the position-detection master point 106 and the client PC 107.

A mobile terminal (wireless communication terminal) 109 is the wireless LAN terminal, and performs wireless LAN communication with the wireless LAN access point 101a to the wireless LAN access point 104a to thereby enable printing on the MFP 101 to MFP 104 by operating the mobile terminal 109. More specifically, the mobile terminal 109 corresponds to a tablet PC terminal, smartphone terminal or the like that is provided with, for example, the wireless LAN terminal function.

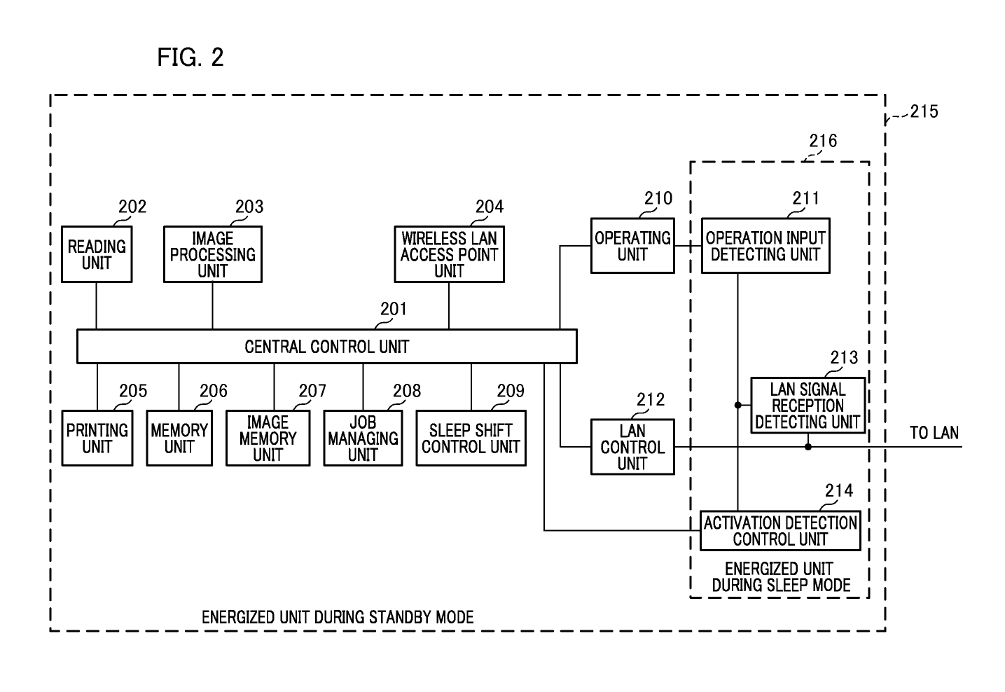

FIG. 2 is a block diagram illustrating the MFP 101 illustrated in FIG. 1. A central control unit 201 performs integral control of the MFP 101. More specifically, the central control unit 201 may be configured by a CPU. A reading unit 202 performs reading of an image in a document during copying and scanning operation. The reading unit 202 more specifically is configured as an image scanner, or the like.

An image processing unit 203 performs various types of image processing in relation to recording an image or reading of the image during copying, scanning or printing operations. More specifically, the image processing unit 203 performs print image processing for printing of image data or RIP processing of print data during printing operations by use of a printing unit 205 described below. The image processing unit 203 performs adjustment processing of an image, or reading correction in relation to image data that has been read by the reading unit 202.

A wireless LAN access point unit 204 includes a function as the access point for the wireless LAN, and performs wireless LAN communication with the mobile terminal 109. The wireless LAN access point unit 204 corresponds to the wireless LAN access point unit 101a. The printing unit 205 prints an image on a recording sheet. In the apparatus according to the present embodiment, printing is executed by use of an electrophotographic method.

A memory unit 206 combines a dynamic memory for use during various types of control operations by the central control unit 201 and a programmable memory that stores programs for execution of control operations. More specifically, the memory unit 206 is configured by a ROM, a RAM, or the like. The image memory unit 207 is a memory configured to store an image and stores and retains an image for printing on the printing unit 205.

A job managing unit 208 is configured to manage various jobs such as copying, printing and scanning that are performed by the MFP 101. A sleep shift control unit 209 controls a shift to sleep mode (power saving mode) by the MFP 101, and notifies the central control unit 201 when an operation input is not received by the MFP 101 or when a print job is not received from the LAN 108, within a predetermined time. The sleep shift control unit 209 according to the present embodiment notifies the central control unit 201 three minutes prior to a sleep shift setting time.

An operating unit 210 is configured from a display unit and an operation button for performance of various operations by a user on the MFP 101. An operation input detecting unit 211 detects the user operation of the operating unit 210, and more specifically, detects that the operation button of the operating unit 210 has been depressed.

A LAN control unit 212 controls LAN communication, and more specifically, controls communication by a network protocol such as TCP/IP. A LAN signal reception detecting unit 213 detects a packet signal from the LAN, and is configured to identify the packet signal from the LAN and to detect an activation packet addressed to its own device in the present embodiment. The LAN control unit 212 and the LAN signal reception detecting unit 213 are connected to the LAN 108.

An activation detection control unit 214 is configured to activate the central control unit 201 in response to detection by the operation input detecting unit 211 that the operation button has been depressed, or detection by the LAN signal reception detecting unit 213 of an activation packet. The MFP 102, the MFP 103, and the MFP 104 are configured from the respective blocks illustrated in FIG. 2 in the same manner as the MFP 101.

Next, a description will be given of switching of energized to each block during sleep mode and standby mode with reference to the block configuration illustrated in the block diagram in FIG. 2. Firstly, during standby mode, a function is enabled in which the blocks (all the blocks in the block diagram in FIG. 2) included in an energized unit 215 during standby mode are supplied with power (energized).

On the other hand, during sleep mode, the function is enabled in which only the blocks included in an energized unit 216 during sleep mode are supplied with power (energized), and the other blocks are not supplied with power. More specifically, in the present embodiment, during sleep mode, the function is enabled in which only the operation input detecting unit 211, the LAN signal reception detecting unit 213, and the activation detection control unit 214 are supplied with power. Therefore, during sleep mode, a power saving configuration is enabled by limiting the blocks that are supplied with power in contrast to standby mode.

Hereinafter, a description will be given of the above configuration in further detail. During standby mode, the function is enabled in which all blocks contained in the energized unit 215 during standby mode are supplied with power, and controlled by the central control unit 201. When the central control unit 201 does not receive the operation input or receive a print job from the LAN 208 for at least a predetermined time period, the central control unit 201 shifts to sleep mode by detecting this situation by the sleep shift control unit 209. During sleep mode, only blocks included in the energized unit 216 during sleep mode are caused to function.

During sleep mode, when the operation input detecting unit 211 detects the user operation, or when the LAN signal reception detecting unit 213 detects a specific packet originating from the LAN, the mode returns from sleep mode to standby mode. That is, in response to the above detection operations, the activation detection control unit 214 causes an activation signal for the central control unit 201 to operate, and the central control unit 201 supplies power again to all blocks included in the energized unit 215 during standby mode, and returns to standby mode.

The wireless LAN access point unit 204 is not energized during sleep mode, and is only energized during standby mode. That is, in the present embodiment, the wireless LAN access point unit 204 can function only during standby mode.

Next, a description will be given of the copying, scanning, and printing operations by the MFP 101 with reference to the system configuration diagram in FIG. 1 and the block diagram of the MFP 101 in FIG. 2. Firstly, when the user performs a copying job, the user places a document to be copied on the reading unit 202, and performs the copy operation by the operating unit 210. The central control unit 201 detects the above operation, and causes the reading unit 202 to read the document, and transfer the read image data to the image processing unit 203 for image processing. Furthermore, the central control unit 201 causes the image data, that has been image processed in the image processing unit 203, to be transferred to the printing unit 205 to thereby print the copy.

In addition, when the user performs a scan job, the user places a document to be scanned on the reading unit 202, and transfers the scan data to the client PC 107 by operation of the operating unit 210. The central control unit 201 detects the above operation, and causes the reading unit 202 to read the document, and transfer the read image data to the image processing unit 203 for image processing. Furthermore, the central control unit 201 transfers the image data that has been image processed to the LAN control unit 212, and then transfers the data to the client PC 107 through the LAN 108.

Furthermore, when the user performs a printing job from the client PC 107 on the MFP 101, the user performs the following operations. Firstly, a direct print is printed immediately by the MFP 101 as a print job instructed from the client PC 107. That is, the user creates a print job with the client PC 107, and transfers the job through the LAN 108 to the MFP 101. The central control unit 201 transfers the print job received through the LAN control unit 212 to the image processing unit 203, and creates print data with RIP processing. The central control unit 201 transfers the print data to the printing unit 205 to perform printing of the print job.

In the present embodiment, the print job may be temporarily stored in the MFP 101, and printed in a secure printing configuration to execute printing by input of password information for the job by the user. That is, the user creates a print job by provision through the client PC 107 of a job ID and password information, and transfers the job through the LAN control unit 108 to the MFP 101. The central control unit 201 transfers the print job received through the LAN control unit 212 to the image processing unit 203 and creates print data by RIP processing. Then the central control unit 201 stores the print data in the image memory 207.

At this time, the central control unit 201 stores the job ID and password information related to the stored print job in association with the job in the job managing unit 208. Then, the user instructs printing by input of the job ID and password information through the operating unit 201 of the MFP 101. When this operation is detected by the operating unit 210, the central control unit 201 confirms a match with the password corresponding to the job Id in accordance with the information related to the job stored in the job managing unit 208. The central control unit 201 transfers the print data stored in the image memory 207 to the printing unit 205 for performance of the print job.

Furthermore, in the present embodiment, a direct printing operation or secure printing operation can be performed from the mobile terminal 109. A description will be given of the operation for performing a print job on the MFP 101 from the mobile terminal 109 with reference to the configuration illustrated in FIG. 1 and the block diagram in FIG. 2. The direct print is printed immediately by the MFP 101 as a print job instructed from the mobile terminal 109. That is, the user creates the print job with the mobile terminal 109, selects the wireless LAN access point 101a, and transfers the job to the MFP 101 through wireless LAN communication. The central control unit 201 transfers the print job received through the wireless LAN access point 101a to the image processing unit 203, and creates print data through RIP processing. The central control unit 201 transfers the print data to the printing unit 205 to perform printing of the print job.

In this case, the print job from the mobile terminal 109 is temporarily stored in the MFP 101, and may be printed in a secure printing configuration to execute printing by input of password information for the job by the user in the same manner as described the above. That is, the user creates a print job by provision through the mobile terminal 109 of a job ID and password information, selects the wireless LAN access point 101a, and transfers the job through wireless LAN communication to the MFP 101. The central control unit 201 transfers the print job received through the wireless LAN access point unit 204 to the image processing unit 203 and creates print data by RIP processing. Then the central control unit 201 stores the print data in the image memory 207.

At this time, the central control unit 201 stores the job ID and password information related to the stored print job in association with the job in the job managing unit 208. Then, the user instructs printing by input of the job ID and password information through the operating unit 201 of the MFP 101. When the operating unit 210 detects this operation, the central control unit 201 checks the match with the password information corresponding to the job ID in accordance with the information related to the job that is stored in the job managing unit 208. Then, the central control unit 201 transfers the print data stored in the image memory 207 to the printing unit 205 for performance of the print job.

Although, in the present embodiment, the performance of a copying job, scanning job, and printing job by the MFP 101 is described the above, execution of a copying job, scanning job, and printing job also can be applied to the MFP 102 to the MFP 104 as well. As described the above, in the present embodiment, depending on the type of job, a job may be executed immediately after receiving a job such as the direct printing job, or may be executed after temporary storage of a job received in the secure print configuration.

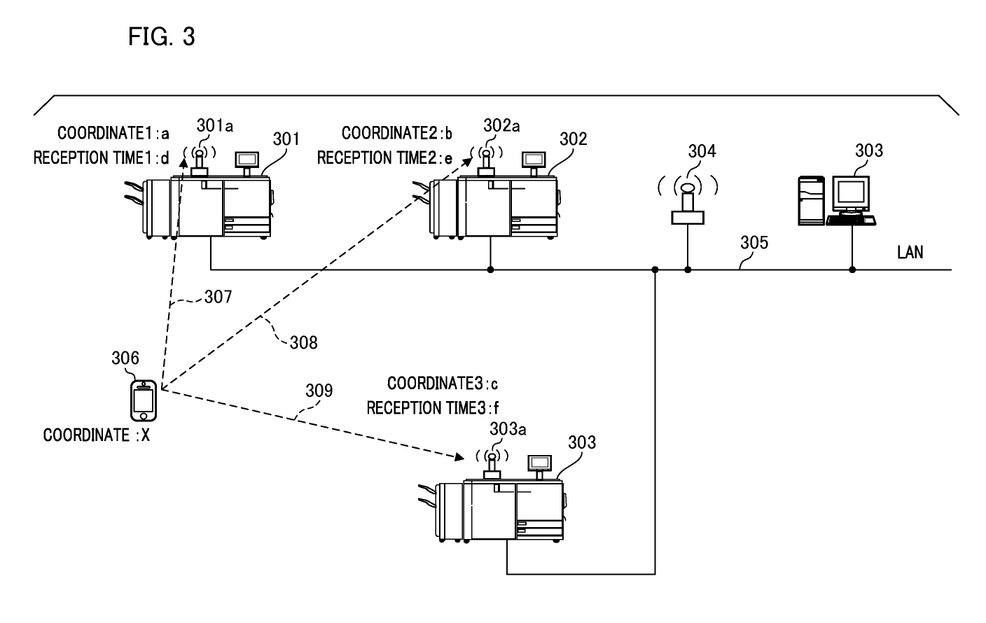

Next, a description will be given of a method for detecting a position of the mobile terminal 109 that is the wireless LAN terminal in the system consisting of the MFP apparatus that includes the wireless LAN function as illustrated in FIG. 1, with reference to FIG. 3. In the present embodiment, the method detecting the position of the mobile terminal 109 is based on a time difference of arrival (TDOA) method. In FIG. 3, three MFP apparatuses MFP 301, MFP 302, and MFP 303 are illustrated. The MFP 301, MFP 302, and MFP 303 illustrate three units of the MFP 101, MFP 102, MFP 103 and MFP 104 that are the plurality of MFP units illustrated in FIG. 1.

The wireless LAN access point 301a, the wireless LAN access point 302a, and the wireless LAN access point 303a respectively illustrate wireless LAN access points mounted on the MFP 301, MFP 302, and MFP 303. In addition, a position-detection MFP-control server 303 corresponds to the position-detection MFP-control server 105 in FIG. 1, and a position detection master point 304 corresponds to the position detection master point 106 in FIG. 1. In the same manner, the LAN 305 corresponds to the LAN 108 in FIG. 1. The mobile terminal 306 corresponds to the mobile terminal 109 in FIG. 1.

Firstly, in advance of position detection, the geographic coordinate information of the MFP 301, MFP 302, and MFP 303 is recorded in the position-detection MFP-control server 303. That is, the position of the MFP 301 is displayed as a coordinate 1:a, and in the same manner, the position of the MFP 302 is displayed as a coordinate 2:b, and the position of the MFP 303 is displayed as a coordinate 3:c, and this coordinate information is recorded in the position-detection MFP-control server 303. Then position detection is performed by the position-detection MFP-control server 303 in accordance with the following method.

Firstly, the position-detection MFP-control server 303 instructs wireless sending of synchronous time information through the LAN 305 to the position detection master point 304. In this manner, the wireless LAN access point 301a, the wireless LAN access point 302a, and the wireless LAN access point 303a receive the information in a wireless configuration, and cause the respective clocks provided therein to be synchronized to the received synchronous time. Then, the wireless LAN access point 301a, the wireless LAN access point 302a, and the wireless LAN access point 303a receive at the same time a wireless LAN signal that is sent in the wireless configuration from the mobile terminal 306.

Here, the time at which the wireless LAN signal, that is sent in the wireless configuration from the mobile terminal 306, is received by the wireless LAN access point 301a of the MFP 301 is denoted as 1:d. In the same manner, the reception time by the wireless LAN access point 302a of the MFP 302 is denoted as reception time 2:e, and the reception time by the wireless LAN access point 303a of the MFP 301 is denoted as reception time 3:f. The reception time information, the reception time 1:d, the reception time 2:e, and the reception time 3:f are respectively notified from the MFP 301, the MFP 302, and the MFP 303 through the LAN 305 to the position-detection MFP-control server 303.

The difference in relation to the reception times at each wireless LAN access point is the result of the distance 307 of the mobile terminal 306 and the MFP 301, the distance 308 of the mobile terminal 306 and the MFP 302, and the distance 309 of the mobile terminal 306 and the MFP 303. Therefore, the position-detection MFP-control server 303 can calculate the coordinate:X of the position of the mobile terminal 306 using a principle of trilateration with reference to the coordinate 1:a, the coordinate 2:b, the coordinate 3:c, the reception time 1:d, the reception time 2:e, and the reception time 3:f. The coordinate 1:a, the coordinate 2:b, and the coordinate 3:c represent coordinate information, and the reception time 1:d, the reception time 2:e, and the reception time 3:f represent reception time information.

As described the above, three wireless LAN access point positions must be used in the time difference of arrival (TDOA) method during position detection according to the present embodiment. That is, in order to detect the position of the mobile terminal, three MFPs must be configured in standby mode and the wireless LAN access points must be functioning.

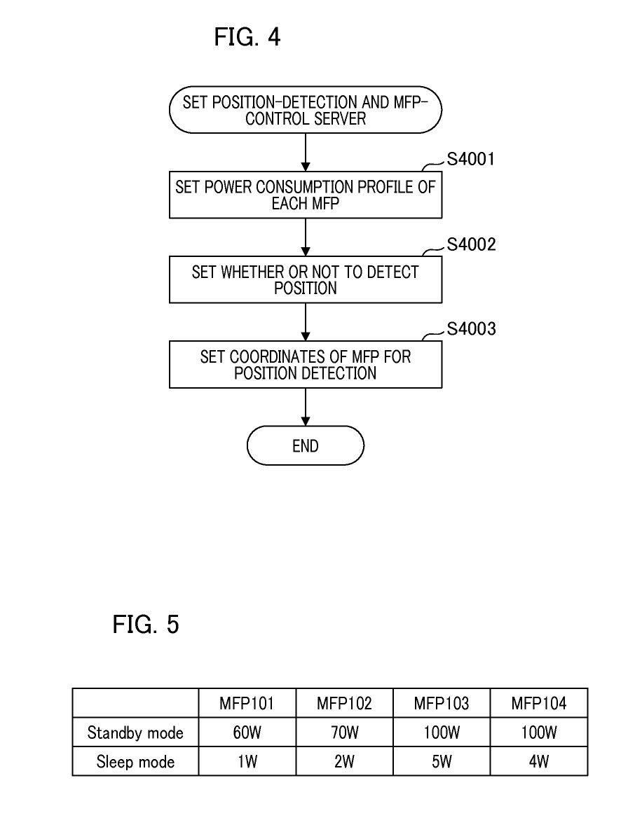

Next, a description will be given of the operation of the system consisting of the MFP apparatus provided with the wireless LAN function according to the present embodiment in further detail below with reference to a flowchart based on the position-detection of the MFP apparatus as described the above. Firstly, a description will be given of the operation of advance settings for the position-detection MFP-control server 303 by a user with reference to the flowchart in FIG. 4.

Firstly a user prerecords the power consumption value of each MFP of the MFP 101, MFP 102, MFP 103 and MFP 104 as a power consumption profile in the position-detection MFP-control server 105. Then, the power consumption profile recorded for each MFP is stored (set) in the position-detection MFP-control server 105 (S4001).

FIG. 5 respectively illustrates power consumption during sleep mode and standby mode of each MFP of the MFP 101, MFP 102, MFP 103 and MFP 104 in the present embodiment. The power consumption values that are illustrated in FIG. 5 are stored in the position-detection MFP-control server 105.

Next, the user selects and sets whether or not to perform position detection of the mobile terminal 109 that is the wireless LAN terminal. The setting is stored in the position-detection MFP-control server 105 (S4002). The user sets the coordinate information for each MFP of the MFP 101, MFP 102, MFP 103 and MFP 104 in the position-detection MFP-control server 105. This coordinate information denotes the geographical coordinates of the MFP that are required for position detection of the mobile terminal 109 that is the wireless LAN terminal as described with reference to FIG. 3. The recorded coordinates for each MFP are stored (set) in the position-detection MFP-control server 105 (S4003). With this manner, the setting of the position-detection MFP-control server 105 is completed.

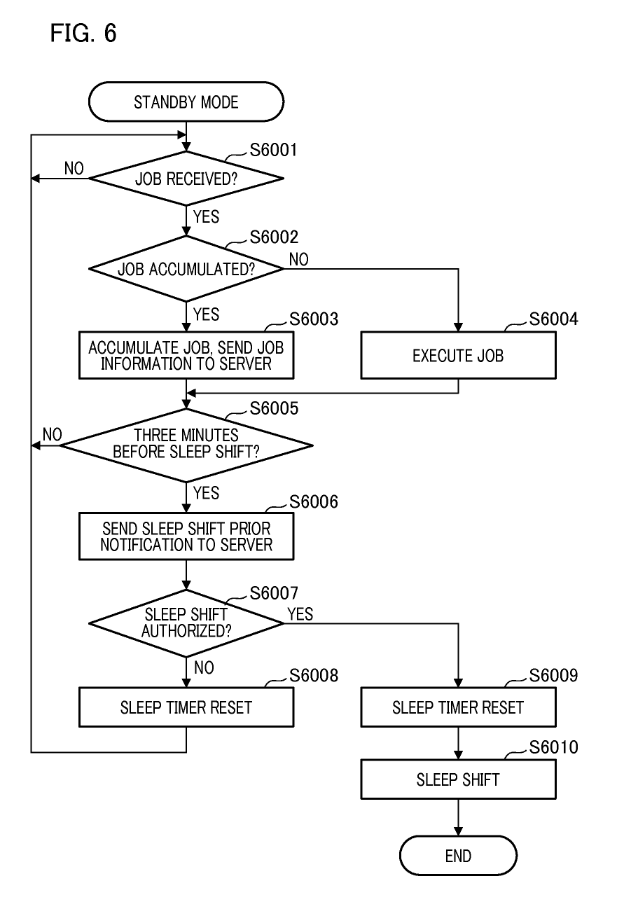

Next, a description will be given of the operations during standby mode and sleep mode in the MFP 101, the MFP 102, the MFP 103 and the MFP 104 in detailed. Firstly, a description will be given of the operation for standby mode for the MFP 101, the MFP 102, the MFP 103 and the MFP 104 with reference to the block diagram illustrated in FIG. 2 and the flowchart illustrated in FIG. 6.

Firstly, in S6001, the central control unit 201 determines whether or not a copy, scan, or print job has been received. More specifically, the central control unit 201 determines whether or not a user has operated the operating unit 210 to perform input of the copy job, or the scan job, or whether the LAN control unit 212 has received transfer of a print job from the LAN 108.

In S6001, when the central control unit 201 determines that the job has not been received (“NO”), the determination is repeated until job is received. On the other hand, in S6001, when the central control unit 201 determines that the job has been received (“YES”), the processing proceeds to S6002. In S6002, the central control unit 201 determines whether or not the received job should be accumulated. More specifically, the central control unit 201 determines whether or not the received job is the secure print job.

In S6002, when the central control unit 201 determines that the job should be accumulated (“YES”), the processing proceeds to S6003. In S6003, the central control unit 201 accumulates the secure print job in the image memory 207, and stores information for the job ID and the password information related to the accumulated print job in the job managing unit 208. In addition, the central control unit 201 transfers the job ID for the accumulated secure print job in a configuration of job information to the LAN control unit 212, and sends the job information through the LAN 108 to the position-detection MFP-control server 105.

On the other hand, in S6002, when the central control unit 201 determines that the job should not be accumulated (“NO”), the processing proceeds to S6004. In S6004, the central control unit 201 determines that the received job is the job for immediate execution, and executes the copy job, scan job, or direct print job.

Next, in S6005, the central control unit 201 determines whether or not a notification indicating before the sleep shift has been received from the sleep shift control unit 209. In the present embodiment, the central control unit 201 receives the notification from the sleep shift control unit 209 three minutes prior to the sleep shift setting time. In S6005, when the central control unit 201 determines that the notification indicating before the sleep shift has not been received (“NO”), the processing returns to S6001, and the central control unit 201 determines whether or not the job has been received.

On the other hand, in S6005, when the central control unit 201 determines that the notification indicating before the sleep shift has been received (“YES”), the processing proceeds to S6006. In S6006, the central control unit 201 transfers the notification indicating before the sleep shift to sleep to the LAN control unit 212 as a sleep shift prior notification, and sends the sleep shift prior notification through the LAN 108 to the position-detection MFP-control server 105.

Next, in S6007, the central control unit 201 determines whether or not the sleep shift is authorized based on authorization or rejection information for the sleep shift received by the LAN control unit 212 through the LAN 108 from the position-detection MFP-control server 105. In S6007, when the central control unit 201 determines that the sleep shift is not authorized based on the rejection information rather than the authorization information received from the position-detection MFP-control server 105 (“NO”), the processing proceeds to S6008. In S6008, the central control unit 201 does not shift to sleep, and resets the sleep timer of the sleep shift control unit 209. Then, the processing returns to S6001, and the central control unit 201 determines whether or not the job has been received.

On the other hand, in S6007, when the central control unit 201 determines that the sleep shift is authorized based on the authorization information received from the position-detection MFP-control server 105 (“YES”), the processing proceeds to S6009. In S6009, the central control unit 201 resets the sleep timer of the sleep shift control unit 209. Then in S6010, the central control unit 201 performs processing of sleep shift. More specifically, the central control unit 201 places the energized units other than the energized unit 216 during sleep mode among units of the energized unit 215 during standby mode illustrated in FIG. 2 to the OFF position. In this manner, each MFP shifts to the sleep state. Thus, the operation during standby mode is completed.

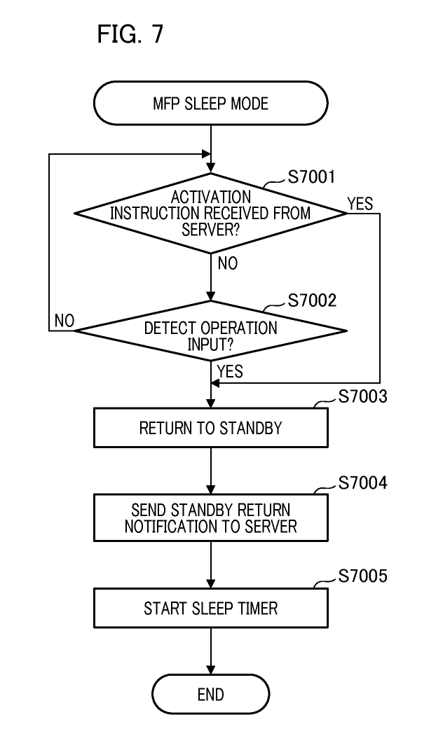

Next, a description will be given of the operation for sleep mode for the MFP 101, the MFP 102, the MFP 103 and the MFP 104 with reference to the block diagram illustrated in FIG. 2 and the flowchart illustrated in FIG. 7. As described above, during sleep mode, the respective units illustrated as the energized unit 216 during sleep mode in FIG. 2 function by being energized.

Firstly, in S7001, the activation detection control unit 214 determines whether or not the activation instruction has been received from the position-detection MFP-control server 105. That is, the LAN signal reception detecting unit 213 determines whether or not the activation packet addressed to its own device has been received through the LAN 108 from the position-detection MFP-control server 105. In S7001, when the activation detection control unit 214 determines that the activation packet has been received (“YES”), the processing proceeds to S7003.

On the other hand, in S7001, when the activation detection control unit 214 determines that the activation packet has not been received (“NO”), the processing proceeds to S7002. In S7002, the activation detection control unit 214 determines whether or not the operation input detecting unit 211 detects an operation input by the user. In S7002, when the activation detection control unit 214 determines that the operation input detecting unit 211 detects the operation (“YES”), the processing proceeds to S7003. On the other hand, when the activation detection control unit 214 determines that the operation input detecting unit 211 does not detect the operation (“NO”), the processing returns to S7001.

Next, in S7003, when the activation detection control unit 214 detects the activation packet from the LAN signal reception detecting unit 213, or detects the input operation from the operation input detecting unit 211, the activation detection control unit 214 activates the central control unit 201. In this manner, the central control unit 201 causes the units, which have been placed to the OFF position during sleep mode, among units of the energized units 215 during standby mode other than the energized unit 216 during sleep mode to be energized by placing to the ON position, to function again, and in this manner, the MFP shifts to standby mode.

Then, in S7004, the central control unit 201 transfers information (detection signal) for returning to standby from the LAN control unit 212 to the position-detection MFP-control server 105 through the LAN 108. Next, in S7005, the central control unit 201 starts the sleep timer by controlling the sleep timer of the sleep shift control unit 209. In this manner, the operations during sleep mode are completed.

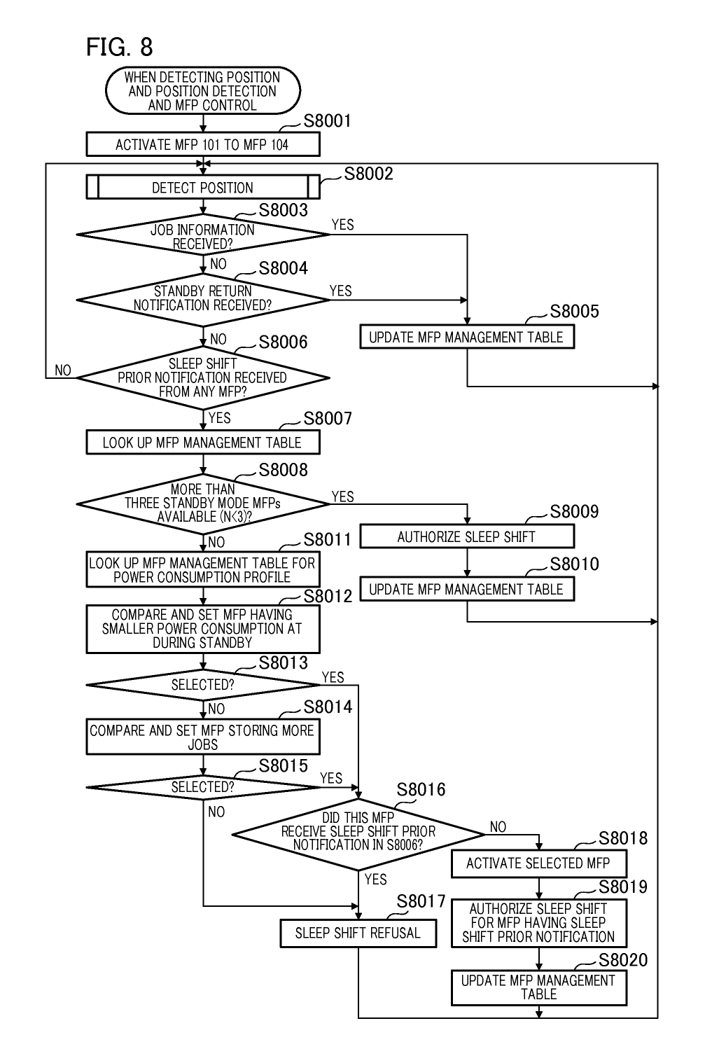

Next, a description will be given of the operations of the position-detection MFP-control server 105 with reference to the flowchart in FIG. 8. Firstly, a description will be given of the operation of the position-detection MFP-control server 105 when a user sets position detection of the mobile terminal 109 that is the wireless LAN terminal, in S4002.

Firstly, in S8001, the position-detection MFP-control server 105 transfers (sends) the respective activation packets (mode switch signal) to the MFP 101, the MFP 102, the MFP 103, and the MFP 104 through the LAN 108. The MFP that is already in standby mode ignores the activation packet, and that MFP maintains standby mode. On the other hand, the MFP that is in sleep mode determines that the activation packet from the position-detection MFP-control server 105 has been detected in S7001, and proceeds to S7003 to thereby return to the standby state. That is, at this point, all of the MFP 101, the MFP 102, the MFP 103, and the MFP 104 are in the standby mode. Here, the position-detection MFP-control server 105 performs management by storing the state that the MFP 101, the MFP 102, the MFP 103, and the MFP 104 are in the standby mode in the MFP management table. Although the MFP management table is not illustrated, the table is stored in an inner portion of the position-detection MFP-control server 105.

Next, in S8002, the position-detection MFP-control server 105 performs position detection of the mobile terminal 109 that is the wireless LAN terminal. More specifically, the position detection is performed by the TDOA method by making use of the wireless LAN access points that are provided on the three MFPs of the MFP 101, the MFP 102, the MFP 103, and the MFP 104 in accordance with the method described above in FIG. 3.

Next, in S8003, the position-detection MFP-control server 105 determines whether or not job information has been received from the MFP. That is, the position-detection MFP-control server 105 determines whether or not the job ID for the secure print job sent when the job is accumulated in S6003 has been received through the LAN 108. In S8003, when the position-detection MFP-control server 105 determines that the job ID has been received (“YES”), the processing proceeds to S8005. On the other hand, when the position-detection MFP-control server 105 determines that the job ID has not been received (“NO”), the processing proceeds to S8004.

In S8004, the position-detection MFP-control server 105 determines whether or not a standby return notification has been received from each MFP. That is, the position-detection MFP-control server 105 determines whether or not the standby return notification sent during standby return by each MFP in S7004 has been received through the LAN 108. In S8004, when the position-detection MFP-control server 105 determines that the standby return notification has been not received (“NO”), the processing proceeds to S8006. On the other hand, when the position-detection MFP-control server 105 determines that the standby return notification has been received (“YES”), the processing proceeds to S8005.

Next, in S8005, the job ID of the job accumulated in each MFP is stored and managed in the MFP management table based on the job information received in S8003. In addition, each MFP stores and manages the ascertained standby or sleep state of each MFP in the MFP management table based on the standby return notification received in S8004.

In S8006, the position-detection MFP-control server 105 determines whether or not the sleep shift notification has been received from any of the MFP 101, the MFP 102, the MFP 103 or the MFP 104. That is, the position-detection MFP-control server 105 determines whether or not the sleep shift prior notification (power saving mode shift signal) sent by any MFP in S6006 has been received through the LAN 108.

In S8006, when the position-detection MFP-control server 105 determines that the sleep shift prior notification has not been received (“NO”), the processing returns to S8002, and position detection of the mobile terminal 109 is performed. On the other hand, when the position-detection MFP-control server 105 determines that the sleep shift prior notification has been received (“YES”), the processing proceeds to S8007.

In S8007, the position-detection MFP-control server 105 looks up the MFP management table that is retained in the inner portion of the server 105 to detect the standby or sleep mode state of each MFP being the MFP 101, the MFP 102, the MFP 103 or the MFP 104.

Then, in S8008, the position-detection MFP-control server 105 looks up the management table to determine whether or not the number of MFPs in standby mode of the MFP 101, the MFP 102, the MFP 103 or the MFP 104 exceeds three units (the unit number N of MFPs is N>3). That is, the position-detection MFP-control server 105 determines whether or not there are more than 3 available wireless LAN access points that are required for position detection of the mobile terminal 109 that is the wireless LAN terminal.

In S8008, when the position-detection MFP-control server 105 determines that there are more than 3 MFPs, of the MFP 101, the MFP 102, the MFP 103 or the MFP 104, in standby mode (“YES”), the processing proceeds to S8009. More specifically, when the four MFPs being the MFP 101, the MFP 102, the MFP 103 or the MFP 104 are in the standby state, the determination in S8008 is “YES”, and the processing proceeds to S8009.

Next, in S8009, the position-detection MFP-control server 105 sends the notification of authorization sleep shift through the LAN 108 to the MFP that has received the sleep shift prior notification in S8006. The notification of authorization sleep shift is received through the LAN 108 by the MFP that has received the sleep shift prior notification, and when the determination in S6007 is “YES”, the MFP executes S6009 and S6010 to thereby shift to sleep mode. In S8010, the position-detection MFP-control server 105 updates, stores and manages the standby and sleep state of each MFP in the MFP table based on the authorization for sleep shift in S8009.

On the other hand, in S8008, when the position-detection MFP-control server 105 determines that there are not more than 3 MFPs in standby mode of the MFP 101, the MFP 102, the MFP 103 or the MFP 104 (“NO”), the processing proceeds to S8011. More specifically, when three of the MFPs being the MFP 101, the MFP 102, the MFP 103 or the MFP 104 are in a standby state, the determination in S8008 is “NO”, and the processing proceeds to S8011.

Next, in S8011, the position-detection MFP-control server 105 looks up and detects the power consumption profile of each MFP that has been stored in S4001. In addition, the position-detection MFP-control server 105 looks up and detects the job information stored in each MFP and the standby and sleep state of each MFP with reference to the MFP management table stored in the inner portion of the server 105.

Next, in S8012, the position-detection MFP-control server 105 compares the standby power consumption of the MFPs that are currently in the sleep mode state with the standby power consumption of the MFPs that received the sleep shift prior notification in S8006 by looking up the MFP management table and the power consumption profile for each MFP. As a result, the MFP that has the smaller standby power consumption is specified and selected as one unit.

Next, in S8013, the position-detection MFP-control server 105 determines whether or not the MFP that has a smaller standby power consumption in S8012 has been specified and selected. In S8013, when the position-detection MFP-control server 105 determines that any of the MFPs are selected (“YES”) in S8012, the processing proceeds to S8016.

On the other hand, in S8013, when the position-detection MFP-control server 105 determines that none of the MFPs are selected (“NO”) in S8012, the processing proceeds to S8014. More specifically, when the determination in S8013 is “NO”, there is a configuration in S8012 in which there is no difference in the standby power consumption between the MFPs that are currently in the sleep mode and the MFPs that have received the sleep shift prior notification in S8006.

Next, in S8014, the position-detection MFP-control server 105 looks up the MFP management table stored therein and specifies and selects an MFP that has both received the sleep shift prior notification and that stores more jobs that the MFPs that are currently in sleep mode as a single MFP.

In S8015, the position-detection MFP-control server 105 determines whether or not the MFP accumulating a higher number of jobs has been specified and selected. In S8015, when the position-detection MFP-control server 105 determines that any of the MFPs has been selected (“YES”), the processing proceeds to S8016.

On the other hand, in S8015, when the position-detection MFP-control server 105 determines that none of the MFPs has been selected (“NO”), the processing proceeds to S8017. More specifically, when the determination in S8015 is “NO”, there is a configuration in S8014 in which there is no difference in the job number that is accumulated by the MFPs that are currently in the sleep mode and the MFPs that have received the sleep shift prior notification in S8006.

Next, in S8016, the position-detection MFP-control server 105 determines whether or not the MFP selected in S8013, or S8015 is the MFP that has received the sleep shift prior notification in S8006. In S8016, when the position-detection MFP-control server 105 determines that the MFP is an MFP that has received the sleep shift prior notification in S8006 (“YES”), the processing proceeds to S8017. On the other hand, when the position-detection MFP-control server 105 determines that the MFP is not the MFP that has received the sleep shift prior notification in S8006 (“NO”), the processing proceeds to S8018.

In S8017, the position-detection MFP-control server 105 sends the sleep shift rejection notification through the LAN 108 to the MFP that has received the sleep shift prior notification in S8006. In this manner, the MFP executes S6008 as a result of the rejection to authorize sleep shift in S6007, and maintains the standby mode state.

In S8018, the position-detection MFP-control server 105 activates an MFP that is specified from the MFPs that are currently in the sleep mode state and that is not the MFP that has received the sleep shift prior notification. That is, the position-detection MFP-control server 105 sends the activation packet through the LAN 108 to such a MFP. The activation packet is received and detected by the MFP in S7001, and therefore, the result of S7001 is “YES”, the processing steps in S7003, S7004 and S7006 are executed, and the MFP returns to the standby mode state.

Note that, in S7004, a standby return notification sent from the MFP through the LAN 108 is received, and thereafter, in S8004, the position-detection MFP-control server 105 determines the result of “YES”, and updates the MFP management table in S8005. Furthermore, the position-detection MFP-control server 105 sends the notification authorizing the sleep shift through the LAN 108 to the MFP that has received the sleep shift prior notification.

Next, in S8019, the MFP is determined by a result “YES” as being authorized to shift to sleep in the determination in S6007, and consequently, the processing steps in S6009 and S6010 are executed, and the MFP that has received a sleep shift prior notification shifts to the sleep mode state.

Then, in S8020, the position-detection MFP-control server 105 updates and stores the standby or sleep mode state of each MFP in the MFP management table that is stored therein. After execution of the processing steps in S8017 and S8020, the position-detection MFP-control server 105 returns to S8002 and performs position detection of the mobile terminal 109.

According to the above, the processing steps in S8011 to S8020 enable the position-detection MFP-control server 105 to either maintain the standby mode for an MFP that has received the sleep shift prior notification, or to control another MFP that is in sleep mode to activate. Therefore, control is enabled to ensure that there are always three MFPs in the standby mode state of the MFP 101, the MFP 102, the MFP 103 and the MFP 104.

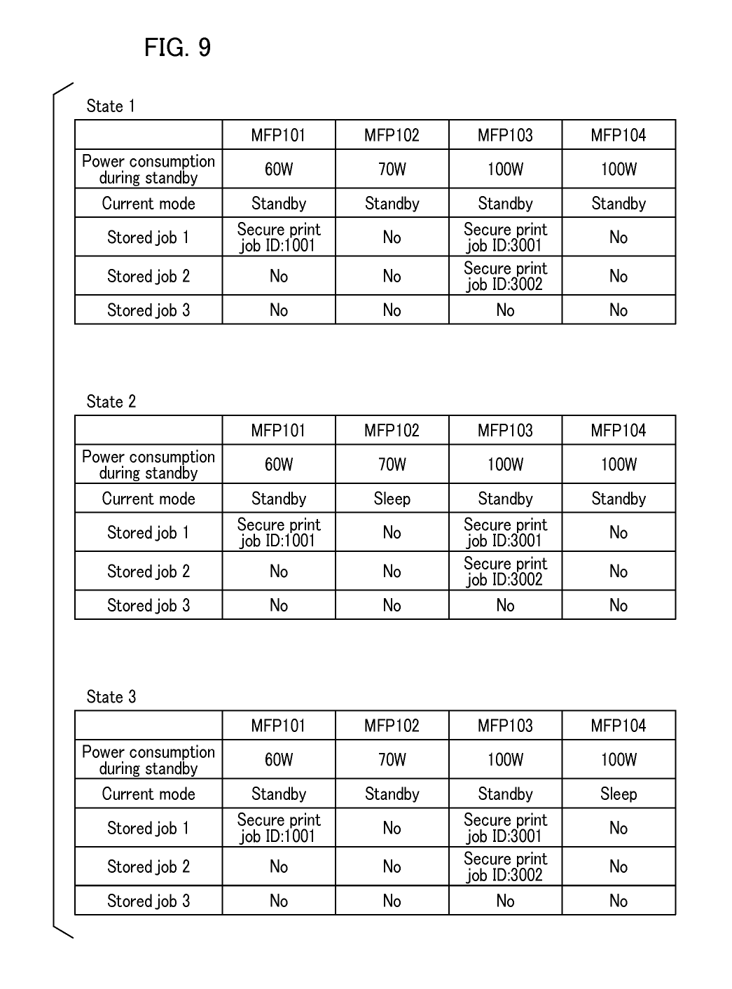

Next, a description will be given of examples of control of the MFP 101, the MFP 102, the MFP 103 and the MFP 104 by the position-detection MFP-control server 105 in further detail making reference to FIG. 9. FIG. 9 is a table illustrating the respective MFP states that are sent from each MFP (for example, mode state, detection signal for presence/absence of stored job), or the power consumption during standby.

Firstly, after activation of the MFP 101, the MFP 102, the MFP 103 and the MFP 104 in S8001, the power consumption profile and the MFP management table that is retained in the position-detection MFP-control server 105 is configured with a state of 1. That is, the power consumption during standby of the MFP 101, the MFP 102, the MFP 103 and the MFP 104 is respectively 60 W, 70 W, 100 W, and 100 W. Furthermore, the current mode (energized state) of all of the MFP 101, the MFP 102, the MFP 103 and the MFP 104 is the standby state. In addition, the MFP 101 has a job, job ID:1001. The MFP 103 has two jobs, job ID:3001 and job ID:3002. The MFP 102 and MFP 104 have no job.

In this context, when it is assumed that there is the sleep shift prior notification from the MFP 102 in S8006 in the state 1, the configuration of the four MFPs in the standby state causes a result of “YES” in S8008, and the processing steps in S8009 and S8010 are executed. In this manner, the sleep mode shift of the MFP 102 is authorized and it transitions to a state 2.

In this context, when it is assumed that there is the sleep shift prior notification from the MFP 101 in S8006 in the state 2, the configuration of the three MFPs in the standby state causes a result of “NO” in S8008. In this context, in S8012, when the standby power consumption of the MFP 101 and the MFP 102 is compared, the MFP 101 is specified since it is the MFP with the smaller standby power consumption. Consequently, the result of S8013 becomes “YES”, and S8016 becomes “YES”. In S8017, the sleep shift for the MFP 101 is rejected, and the MFP 101 maintains the standby mode state. Therefore, the state 2 is maintained without change.

On the other hand, when it is assumed that there is the sleep shift prior notification from the MFP 104 in S8006 in the state 2, the configuration of the three MFPs in the standby state results in “NO” in S8008. In this context, in S8012, when the standby power consumption of the MFP 102 and the MFP 104 is compared, the MFP 102 is (preferentially) specified since it is the MFP with the relatively smaller standby power consumption. Consequently, the result of S8013 becomes “YES”, and S8016 becomes “NO”. In S8018, the MFP 102 is activated. Therefore, the sleep shift prior notification for the MFP 104 in S8019 is authorized, and the MFP 104 shifts to sleep, and transitions to a state 3.

Next, when it is assumed that there is the sleep shift prior notification from the MFP 103 in S8006 in the state 3, the configuration of the three MFPs in the standby state causes a result of “NO” in S8008. In this context, in S8012, when the standby power consumption of the MFP 103 and the MFP 104 is compared, there is no difference in the standby power consumption of the MFP 103 and the MFP 104, and therefore, no MFP is specified, and S8013 becomes “NO”.

Then, when the number of jobs stored in the MFP 103 and the MFP 104 is compared, the MFP 103 is (preferentially) specified since it is the MFP that stores a relatively larger number of jobs. Consequently, the result of S8015 becomes “YES”, and S8016 becomes “YES”. In S8017, the shift to sleep of the MFP 103 is rejected, and the MFP 103 maintains the standby mode state. Therefore the state 3 is maintained without change.

As described the above, in the control steps in S8001 to S8020 by the position-detection MFP-control server 105, at least three MFPs are constantly configured in a standby mode state, and therefore the wireless LAN access points mounted on those MFPs are caused to function. As a result, the number of wireless LAN access points, that are required in S8002 during position detection of the mobile terminal 109 that is the wireless LAN terminal, is always satisfied.

In S8012, the MFP that has the lower standby power consumption is selected and can be activated to the standby state, and therefore the system can operate on a lower power consumption. Furthermore, in S8014, the MFP that stores the higher number of jobs is activated to the standby state. Therefore, efficient operation of the system is enabled by preventing unnecessary sleep shift as a result of activating the MFP having the higher possibility of subsequent execution of printing in relation to the print job by the user.

In S6005, each MFP is configured to send the sleep shift prior notification three minutes prior to the sleep shift time, and therefore, the position-detection MFP-control server 105 performs sleep and standby control in relation to each MFP by detecting the sleep shift prior notification in S8006. Therefore, the position-detection MFP-control server 105 activates a MFP that is in a sleep state in S8018, and then can cause the MFP that has received the sleep shift prior notification to shift to sleep in S8019.

As a result, due to the fact that a sufficient time elapses after use is enabled in relation to the wireless LAN by energized to the wireless LAN access points of the MFP that is activated from the sleep state, the MFP that has received the sleep shift prior notification shifts to sleep, and the wireless LAN access point is placed in the OFF position. In this manner, when the handoff time during switching of the wireless LAN access points is considered, the required number (greater than or equal to a predetermined number) of the wireless LAN access points can be constantly operated.

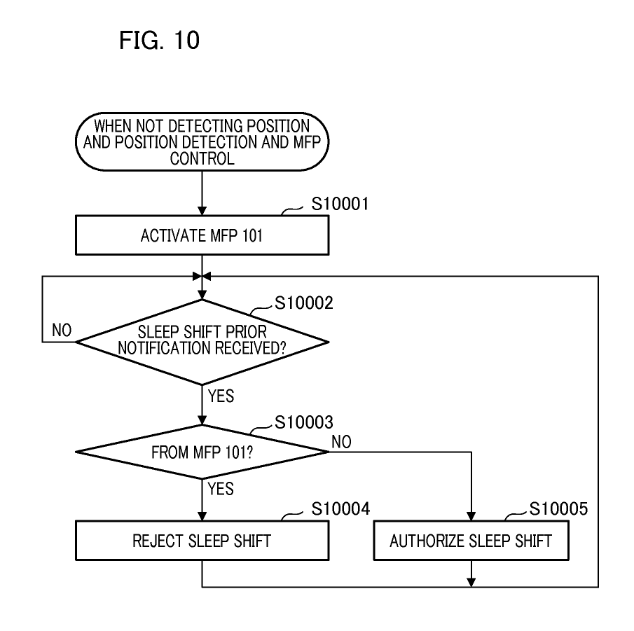

Next, a description will be given of the operation of the position-detection MFP-control server 105 with reference to the flowchart in FIG. 10 when a setting has been performed by the user in S4002 to not execute position detection of the mobile terminal 109 that is the wireless LAN terminal. AS described the above, when the position-detection of the mobile terminal 109 is not performed, there is no requirement to always ensure the standby state in relation to three of the MFP 101, the MFP 102, the MFP 103 or the MFP 104.

One of the wireless LAN access points 101a to 104a of the MFP 101, the MFP 102, the MFP 103 or the MFP 104 must function in order for the mobile terminal 109 to perform wireless LAN communication with the wireless LAN access points. As a result, in the present embodiment, control is performed so that the MFP 101 constantly maintains the standby state, and therefore at least one wireless LAN access point (the wireless LAN access point 101a) is configured in a functioning state.

Firstly, in S10001, the position-detection MFP-control server 105 forwards the activation packet to the MFP 101 through the LAN 108. In this context, when the MFP 101 is already in standby mode, the activation packet is ignored, and the MFP maintains standby mode. On the other hand, when the MFP 101 is in sleep mode and it is determined that the activation packet from the position-detection MFP-control server 105 is detected, the processing proceeds to S7003, and the MFP returns to the standby state.

Next, in S10002, the position-detection MFP-control server 105 determines whether or not the sleep shift notification has been received from each MFP. That is, the position-detection MFP-control server 105 determines whether or not the sleep shift prior notification sent by each MFP in S6006 has been received through the LAN 108. In S10002, when the position-detection MFP-control server 105 determines that the sleep shift prior notification has not been received (“NO”), the determination is repeated until the sleep shift prior notification is received. On the other hand, in S10002, when the position-detection MFP-control server 105 determines that the sleep shift prior notification has been received (“YES”), the processing proceeds to S10003.

Next, in S10003, the position-detection MFP-control server 105 determines whether or not the sleep shift prior notification received in S10002 is from the MFP 101. In S10003, when the position-detection MFP-control server 105 determines that the sleep shift prior notification has been received from the MFP 101 (“YES”), the processing proceeds to S10004. On the other hand, in S10003, when the position-detection MFP-control server 105 determines that the sleep shift prior notification has not been received from the MFP 101 (“NO”), the processing proceeds to S10005.

In S10004, the position-detection MFP-control server 105 sends a notification rejecting sleep shift through the LAN 108 to the MFP 101 that received the sleep shift prior notification. In this manner, the MFP 101 rejects the non-authorized sleep shift in S6007, and executes the processing step in S6008 to thereby maintain the standby mode state.

In S10005, the position-detection MFP-control server 105 sends the notification of authorization sleep shift to the MFP 101 through the LAN 108 that received the sleep shift prior notification. In this manner, that MFP is authorized to shift to sleep mode in S6007, and executes the processing steps in S6009 and S6010 to thereby shift to sleep mode.

After the processing steps in S10004 and S10005, the position-detection MFP-control server 105 returns to S10002 and repeats the determination of whether or not the sleep shift notification has been received. In the control of processing steps S10001 to S10005, the position-detection MFP-control server 105 ignores job information sent from an MFP in S6003 and standby return information sent from an MFP in S7004.

In this manner, in S4002, when a user performs a setting to not perform position detection of the mobile terminal 109 that is the wireless LAN terminal, the MFP 101 constantly maintains the standby state. On the other hand, the MFP 102, the MFP 103 and the MFP 104 perform an independent determination in relation to sleep shift or returning to standby irrespective of an instruction from the position-detection MFP-control server 105.

Therefore, the wireless LAN access point 101a mounted in the MFP 101 is constantly in operation, and although position detection of the mobile terminal 109 that is the wireless LAN terminal is not performed, wireless LAN communication by the wireless LAN access point 101a is constantly enabled.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-182483, filed Sep. 3, 2013, which is hereby incorporated by reference herein in its entirety.

What is claimed is:

1. An information processing system, comprising:
a wireless communication terminal;
a plurality of information processing apparatuses having an access point configured to perform wireless communication with the wireless communication terminal; and
a managing apparatus configured to manage the information processing apparatuses,
wherein the information processing apparatuses comprises:
a detecting unit configured to detect an energized state of the access point and send the energized state as a detection signal to the managing apparatus, and
a control unit configured to switch the access point to a standby mode or a power-saving mode,
wherein the managing apparatus comprises:
a sending unit configured to send a mode switch signal to the control unit in response to the detection signal from the detecting unit, and
wherein when a position of the wireless communication terminal is detected, the sending unit sends the mode switch signal in response to the detection signal to the control unit in order to switch a predetermined number or more of access points to the standby mode, and the control unit which has received the mode switch signal switches the access points to the standby mode.

2. The information processing system according to claim 1, wherein the predetermined number is 3.

3. The information processing system according to claim 1, wherein the sending unit preferentially selects the information processing apparatus that has a relatively smaller power consumption when the access point is in the standby mode, and sends the mode switch signal.

4. The information processing system according to claim 1, further comprising:
an accumulating unit configured to accumulate a job,
wherein the sending unit preferentially selects the information processing apparatus that has the accumulating unit accumulating the job, and sends the mode switch signal.

5. The information processing system according to claim 1, wherein, when the access point that is in the standby mode shifts to the power-saving mode, the power-saving mode shift signal is sent to the managing apparatus in advance, and
wherein the managing apparatus further comprises
a determining unit configured to determine whether or not the access point is caused to shift to the power-saving mode upon receipt of the power-saving mode shift signal, and
wherein, when the determining unit determines that the access point is caused to shift to the power-saving mode, the sending unit sends the mode switch signal in order to switch to the power-saving mode.

6. The information processing system according to claim 5, wherein before the sending unit sends the mode switch signal to switch to the power-saving mode, the sending unit sends the mode switch signal in order to switch the predetermined number or more of access points, except for the access point that switches to the power-saving mode, to the standby mode.

7. A managing apparatus configured to manage wireless communication terminal and a plurality of information processing apparatuses having an access point configured to perform wireless communication with the wireless communication terminal, the managing apparatus comprising:
a sending unit send a mode switch signal in order to switch the access point to the standby mode or power-saving mode, to the information processing apparatus in response to a detection signal indicating an energized state of the access point from the information processing apparatus,
wherein, when the position of the wireless communication terminal is detected, the sending unit sends the mode switch signal in response to the detection signal in order to switch a predetermined number or more of the access points to the standby mode.

8. A method for control of a managing apparatus configured to manage a plurality of information processing apparatuses having an access point configured to perform wireless communication with a wireless communication terminal, the method comprising:
sending a mode switch signal in order to switch the access point to a standby mode or a power-saving mode, to the information processing apparatus in response to the a detection signal indicating an energized state of the access point from the information processing apparatus,
wherein, when the position of the wireless communication terminal is to be detected, in the sending, the mode switch signal is sent in order to switch a predetermined number or more of the access points to the standby mode in response to the detection signal.

9. A non-transitory storage medium on which is stored a computer program for making a computer execute a control method of control of a managing apparatus configured to manage a plurality of information processing apparatuses having an access point configured to perform wireless communication with a wireless communication terminal, the method comprising:
sending a mode switch signal in order to switch the access point to a standby mode or a power-saving mode, to the information processing apparatus in response to the a detection signal indicating an energized state of the access point from the information processing apparatus,
wherein, when the position of the wireless communication terminal is to be detected, in the sending, the mode switch signal is sent in order to switch a predetermined number or more of the access points to the standby mode in response to the detection signal.
